(19) United States
(12) Patent Application Publication
(10) Pub. No.: US 2021/0310304 A1
(43) Pub. Date: Oct. 7, 2021

(54) Barrier Shield

(71) Applicants: Michael DeGraff, Sedro Woolley, WA (US); Robert McClelland, Gold Bar, WA (US); Shane Davidson, Marysville, WA (US); Tristan Swanson, Sultan, WA (US); Malchijah Boyd, Monroe, WA (US); David Keegan, Puyallup, WA (US)

(72) Inventors: Michael DeGraff, Sedro Woolley, WA (US); Robert McClelland, Gold Bar, WA (US); Shane Davidson, Marysville, WA (US); Tristan Swanson, Sultan, WA (US); Malchijah Boyd, Monroe, WA (US); David Keegan, Puyallup, WA (US)

(21) Appl. No.: 16/886,666

(22) Filed: May 28, 2020

Related U.S. Application Data
(60) Provisional application No. 63/004,961, filed on Apr. 3, 2020.

(51) Int. Cl. E06B 9/72; E06B 9/50

(52) U.S. Cl. CPC E06B 9/72; E06B 9/44; E06B 9/50

(57) ABSTRACT

Disclosed are, among other things, a barrier shield to prevent people from passing pathogens to each other while they are communicating in person.

### FIELD

This disclosure relates to a barrier shield.

### BACKGROUND

There are times where a physical barrier may be useful in preventing bacteria or viruses, for example, from being communicated between people. Face masks, gowns, or social distancing may be used for this purpose.

### SUMMARY

The instant application discloses, among other things, a shield allowing a person to have protection disease communication from another by providing a clear shield to prevent bacteria, viruses, or other pathogens from being spread by coughing, sneezing, or touching, for example. As an example, a pharmacist may want to provide services to the public, but may need protection during a flu season, or during a pandemic, for example. A shield may be used to separate the pharmacist from a client.

### BRIEF DESCRIPTION OF THE DRAWINGS

FIG. 1 is an example of a barrier shield, according to one implementation.

FIG. 2 is an example of a barrier shield, according to another implementation.

FIG. 3 is an example of a shield, according to yet another implementation.

### DETAILED DESCRIPTION

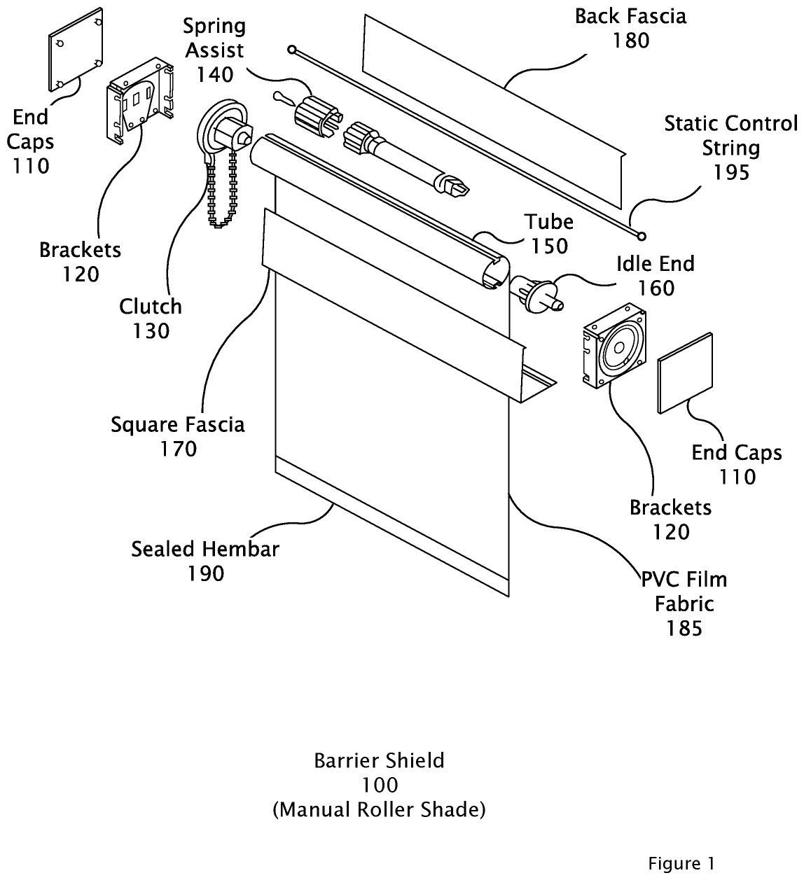

FIG. 1 is an example of a Barrier Shield 100, according to one implementation. This implementation is a manual roller shade.

Polyvinyl chloride (PVC) may be used to form a clear film. PVC Film 185 may roll from Tube 150, with Sealed Hembar 190 may keep PVC Film 185 from wrinkling while hanging. One having skill in the art will recognize that various materials may be used to provide a clear film. Square Fascia 170, End Caps 110, and Back Fascia 180 may hide the inner mechanism of Barrier Shield 100, providing a better aesthetic, and protecting the inner mechanism from dust or other contaminants. Tube 150, Sealed Hembar 190, Square Fascia 170, End Caps 110, Back Fascia 180, Idle End 160, and Brackets 120 may make up a support system to support the various components of Barrier Shield 100.

Tube 150 may be supported by Idle End 160 on one end, and Clutch 130 on the opposite end. Idle End 160 and Clutch 130 may be supported by Brackets 120. Spring Assist 140 may be disposed within Tube 150, assisting when rolling or unrolling PVC Film 185. Clutch 130 may allow PVC Film 185 to be rolled up when it is not being used.

Static Control String 195 may be made of any conductive material that may drain any static buildup to ground, which may prevent a large static charge from building up. Static control string may be disposed such that it touches PVC Film 185 when PVC Film 185 is rolled or unrolled.

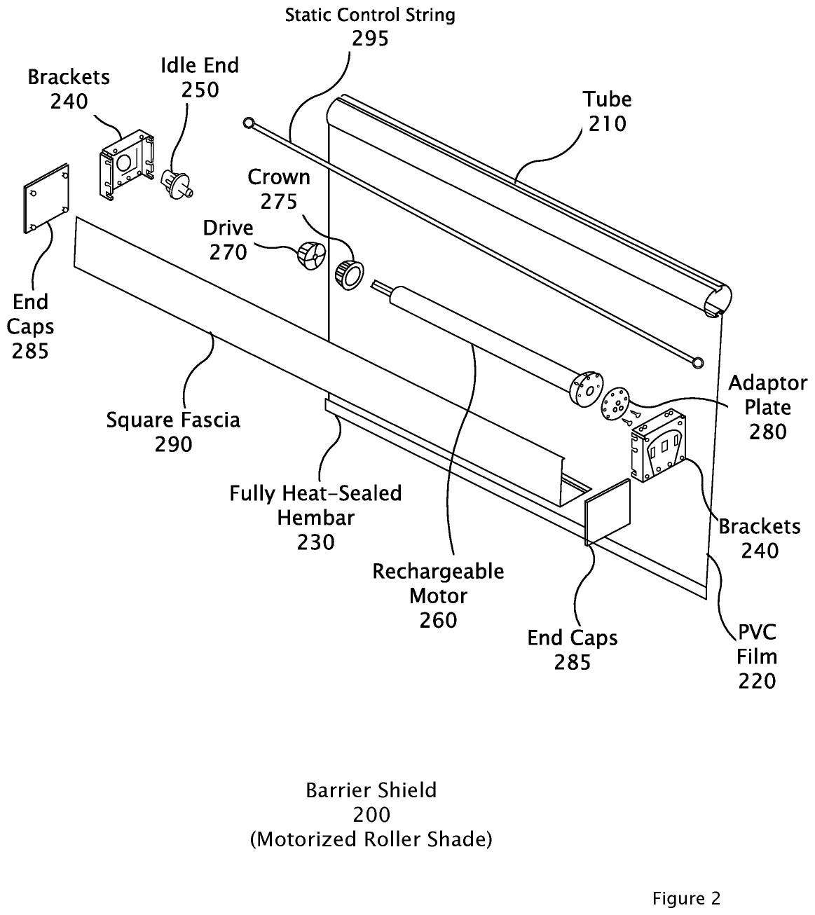

FIG. 2 is an example of a Barrier Shield 200, according to one implementation. This implementation may be a motorized roller shade. PVC Film 220 may roll from Tube 210, and Fully Heat-Sealed Hembar 230 may keep PVC Film 220 from wrinkling while hanging. Square Fascia 290 and End Caps 285 may hide the inner mechanism of Barrier Shield 200, providing a better aesthetic, and protecting the inner mechanism from dust or other contaminants.

Tube 210 may be supported by Idle End 250, Drive 270, Crown 275 on one end, and Adaptor Plate 280 on the opposite end. Idle End 250 and Adaptor Plate 280 may be supported by Brackets 240. Rechargeable Motor 260 may be disposed within Tube 210, which may turn Tube 210 to roll or unroll PVC Film 220.

Tube 210, Fully Heat-Sealed Hembar 230, Square Fascia 290, End Caps 285, Idle End 250, and Brackets 240 may make up a support system to support the various components of Barrier Shield 200.

Static Control String 295 may be made of nylon or another conductive material that may drain any static buildup to ground, which may prevent a large static charge from building up. Static Control String 295 may be disposed such that it touches PVC Film 220 when PVC Film 220 is rolled or unrolled, which may allow static charges to be safely grounded. If static is permitted to build up, it may discharge and cause damage to electronics in Rechargeable Motor 260, for example. For example, Rechargeable Motor 260 may have memory to store when to stop extending or retracting, and a static discharge may erase that memory, which may cause damage to Barrier Shield 200.

Static Control String 295 may be fastened to Brackets 240, which may be operably coupled to a ground connection of Rechargeable Motor 260. Static Control String 295 may be attached via a conductive connection, or may be pressure fit between Brackets 240 and Square Fascia 290. One having skill in the art will recognize that many different ways may be used to ground Static Control String 295 to a ground for Rechargeable Motor 260.

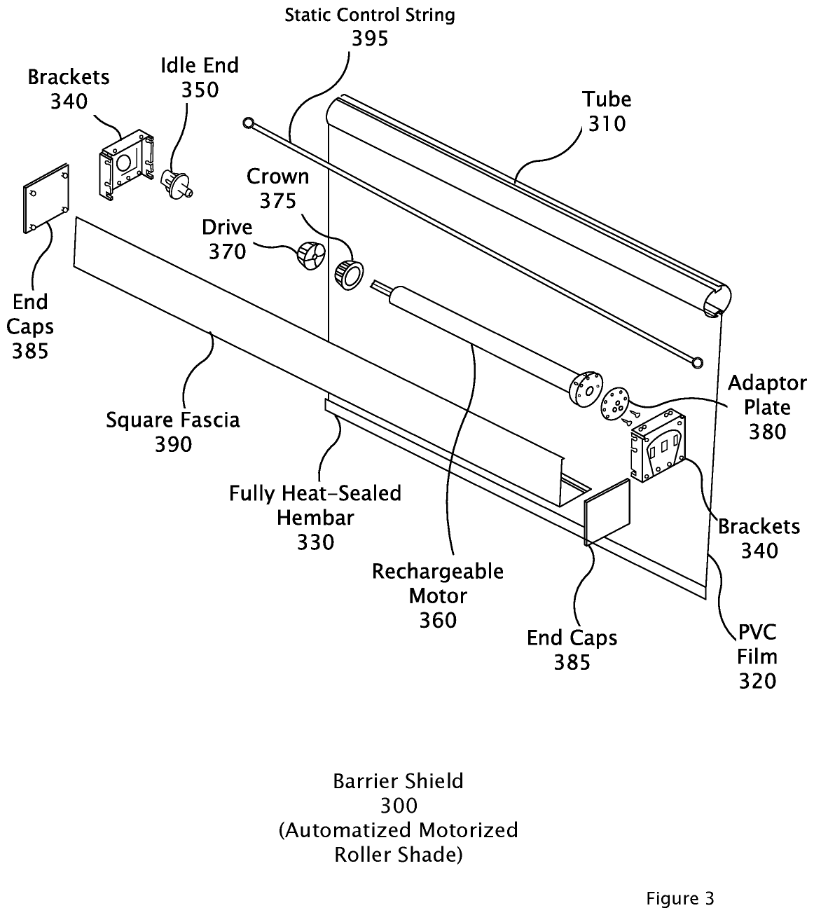

FIG. 3 is an example of a Barrier Shield 300, according to one implementation. This implementation may be an automatized motorized roller shade. PVC Film 320 may roll from Tube 310, and Fully Heat-Sealed Hembar 330 may keep PVC Film 320 from wrinkling while hanging. Square Fascia 390 and End Caps 385 may hide the inner mechanism of Barrier Shield 300, providing a better aesthetic, and protecting the inner mechanism from dust or other contaminants.

Tube 310 may be supported by Idle End 350, Drive 370, Crown 375 on one end, and Adaptor Plate 380 on the opposite end. Idle End 350 and Adaptor Plate 380 may be supported by Brackets 340. Rechargeable Motor 360 may be disposed within Tube 310, which may turn Tube 310 to roll or unroll PVC Film 320.

Rechargeable Motor 260 may be disposed within Tube 210, which may turn Tube 210 to roll or unroll PVC Film 220.

Tube 210, Fully Heat-Sealed Hembar 230, Square Fascia 290, End Caps 285, Idle End 250, and Brackets 240 may make up a support system to support the various components of Barrier Shield 200.

Tube 310, Fully Heat-Sealed Hembar 330, Square Fascia 390, End Caps 385, Idle End 350, and Brackets 340 may make up a support system to support the various components of Barrier Shield 300.

Static Control String 395 may be made of nylon or another conductive material that may drain any static buildup to ground, which may prevent a large static charge from building up. Static Control String 395 may be disposed such that it touches PVC Film 320 when PVC Film 320 is rolled or unrolled, which may allow static charges to be safely grounded. If static is permitted to build up, it may discharge and cause damage to electronics in Rechargeable Motor 360, for example. For example, Rechargeable Motor 360 may have memory to store when to stop extending or retracting, and a static discharge may erase that memory, which may cause damage to Barrier Shield 300.

Static Control String 395 may be fastened to Brackets 340, which may be operably coupled to a ground connection of Rechargeable Motor 360. Static Control String 395 may be attached via a conductive connection, or may be pressure fit between Brackets 340 and Square Fascia 390. One having skill in the art will recognize that many different ways may be used to ground Static Control String 395 to a ground for Rechargeable Motor 360.

While various aspects and embodiments have been disclosed herein, other aspects and embodiments will be apparent to those skilled in the art. The various aspects and embodiments disclosed herein are for purposes of illustration and are not intended to be limiting, with the true scope and spirit of the invention being indicated by the following claims.

1. A blind, comprising:
a film made of clear material disposed on a tube, the tube operable to allow the film to be rolled up or down;
a motor operable to turn the tube;
a support system operable to support the motor, the film, and the tube; and
a conductive string, disposed to touch the film when the film is rolled up or down, the conductive string operable to ground static electricity generated by the film.
